(19) United States
(12) Patent Application Publication
(10) Pub. No.: US 2002/0079759 A1
(43) Pub. Date: Jun. 27, 2002

(54) Autonomous braking assembly for bicycle

(76) Inventor: Shui-Jung Chen, Taipei (TW)

Correspondence Address: BIRCH, STEWART, KOLASCH & BIRCH, LLP, P.O.Box 747, Falls Church, VA, 22040-0747, US

(21) Appl. No.: 09/745,535

(22) Filed: Dec. 26, 2000

(51) Int. Cl. H02K 1/00

(52) U.S. Cl. 310/75 C; 310/216; 310/254

(57) ABSTRACT

A braking assembly, comprise a rotor defining a circular receiving space, a copper ring is arranged within said receiving space for increasing the braking effect. A stator is arranged within said receiving space of said rotor and includes a plurality of poles each pole is mounted with an exciting coils.

### FIELD OF THE INVENTION

The present invention relates to a braking assembly, and more particularly to an autonomous braking assembly for use with a sport bicycle or the like. The DC power supplied to the braking device is provided by an adapter after modulating and rectifying the input electrical current. The controlling for the magnitude of the braking force and power for dashboard are also powered by the adapter. As a result, a dynamo can be completely eliminated thereby simplifying the structure as well as reducing the cost.

### DESCRIPTION OF THE PRIOR ART

As shown in FIGS. 3 and 4, a conventional sport bike or the like includes a braking device which serves also a loading device. U.S. Pat. No. 5,986,370 typically discloses such a device. The loading assembly includes a dynamo and a braking device. The dynamo includes a stator including exciting coils (A) and a rotor having a permanent magnet (B). The braking device includes a rotor made of silicon steel (D) and a stator having exciting coils (C) and which is adjacent to the stator (A) of the dynamo. In the above described structure, the stator (C) exciting coils of the braking device is arranged along perimeter. As a result, the manufacturing cost is inevitably increased. In addition, even the braking force can be reduced because the braking force F=K B² A, wherein B is the density of magnetic flux, while A is the reaction area. Because when the amperage is fixed, the flux distribution generated is largely distributed in the pole. As a result, the density of magnetic flux is reduced, and the braking force is reduced accordingly. Accordingly, there is still a room to provide a better device.

### SUMMARY OF THE INVENTION

It is an object of this invention to provide a braking assembly with improved structure in which at least a pair of “U” shaped silicon steel symmetrically and secured arranged on a plastic rack. Exciting coils are wound on a pole defined by the “U” shaped device thereby reducing the manufacturing cost while increasing the braking power as well as braking performance.

It is still an object of this invention to provide a braking assembly in which the exciting coils are firstly wound up, then assembling the coils to the pole thereby reducing the manufacturing cost while increasing excellent insulating performance.

In order to achieve the objects set forth, a braking assembly in accordance with the present invention comprise a rotor defining a circular receiving space, a copper ring is arranged within said receiving space for increasing the braking effect. A stator made of silicon steel is arranged within said receiving space of said rotor and includes a plurality of poles each pole is mounted with exciting coils. When the exciting coils are energized by a DC current, the rotor is attracted by the stator thereby braking the rotor. Characterized in that the poles of the stator are configured by a pair of “U” shaped silicon steel sheet which is symmetrically arranged and secured on a plastic rack.

According to one aspect of the present invention, because the silicon steel is arranged locally and which occupies less than one half of the perimeter thereby reducing the material of silicon steel as well as the coils. Consequently, the manufacturing cost is reduced.

According to another aspect, because the number of the poles is reduced, the magnetic flux density acted thereon is increased and the braking performance is increased.

### BRIEF DESCRIPTION OF THE DRAWINGS

The invention will be best understood by reference to the following description taken in connection with the accompanying drawings.

FIG. 1 is a plan view of a braking assembly in accordance with the present invention;

FIG. 2 is sketch view of a stator (silicon steel) of the present invention with according dimension;

FIG. 3 is a plan view of a prior art autonomous braking assembly;

FIG. 4 is a sketch view of exciting coils of FIG. 3 with dimension; and

FIG. 5 is a second embodiment of a stator (silicon steel) in accordance with the present invention.

### DETAILED DESCRIPTION OF PREFERRED EMBODIMENT

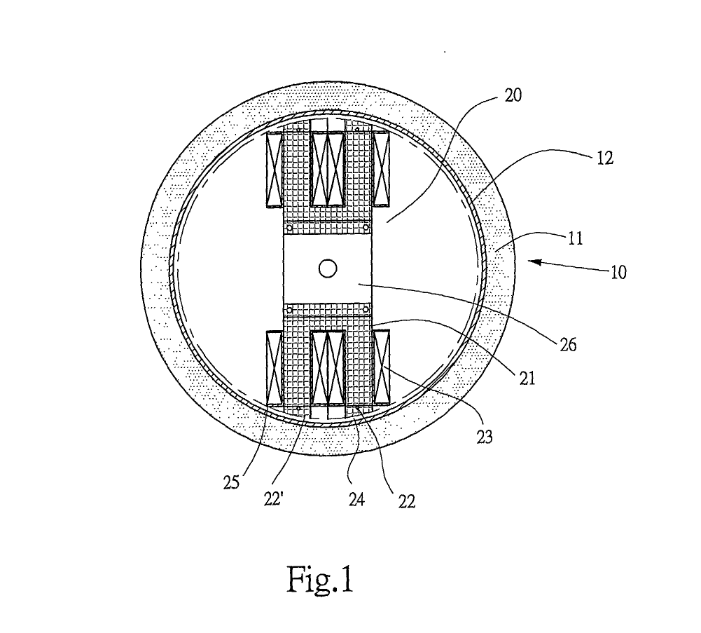

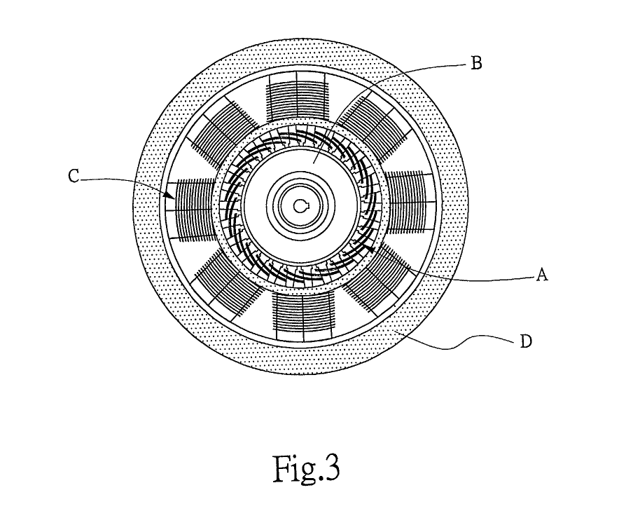

Referring to FIGS. 1 to 4, the braking assembly in accordance with the present invention includes a rotor 10 which is made from cast iron or the equivalent. The rotor 10 defines a receiving space in which a copper ring or aluminum ring 12 is arranged therein to increase the braking performance. A stator 20 is arranged within the receiving space of the rotor 10. The stator 20 is configured by silicon steel 21 which forms a plurality of poles 22, 22′ each is enveloped with an exciting coil 23. When the exciting coil 23 is energized by a DC current, the exciting coils 23 is excited such that each pole 22 is generated with magnetic flux which penetrates through a gap 24, the copper or aluminum ring 12, and finally enters the rotor 11 made by cast iron. Then the magnetic flux flows back to the other pole 22′ to complete the magnetic path. When the rotor 10 is rotated by peddling, the magnetic flux on the rotor 10 varies such that an eddy current is generated in the copper or aluminum ring 12 and the cast iron 11. The eddy current will react with the magnetic flux such that a braking force is generated. The braking torque can be readily controlled by the magnitude of the DC current flows through the exciting coils. Since this is known to the skill in the art and no detailed description is given.

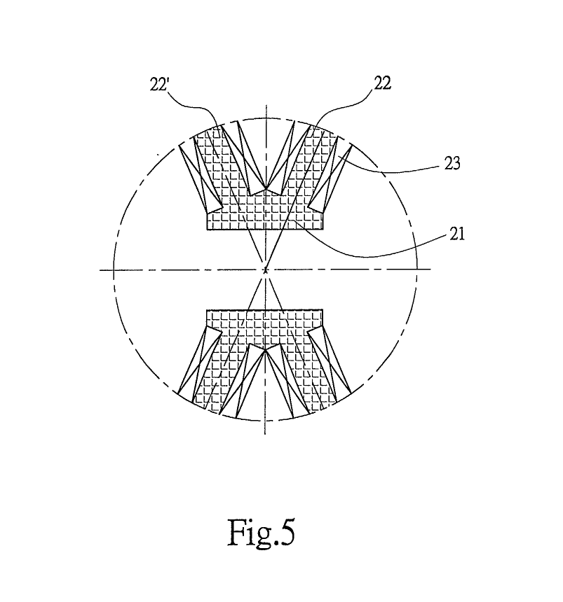

The improvement of the present invention is the poles 22, 22′ of the stator 20 of the braking assembly is configured by a pair of “U” shaped silicon steels 21 which are symmetrically secured on a plastic rack 26. The number of the silicon steels 21 can be readily arranged according to the required braking force. For example, one, two and more than two silicon steels 21 can be arranged therein. In addition, the silicon steel 21 may have a “V” shaped configuration, such as shown in FIG. 5.

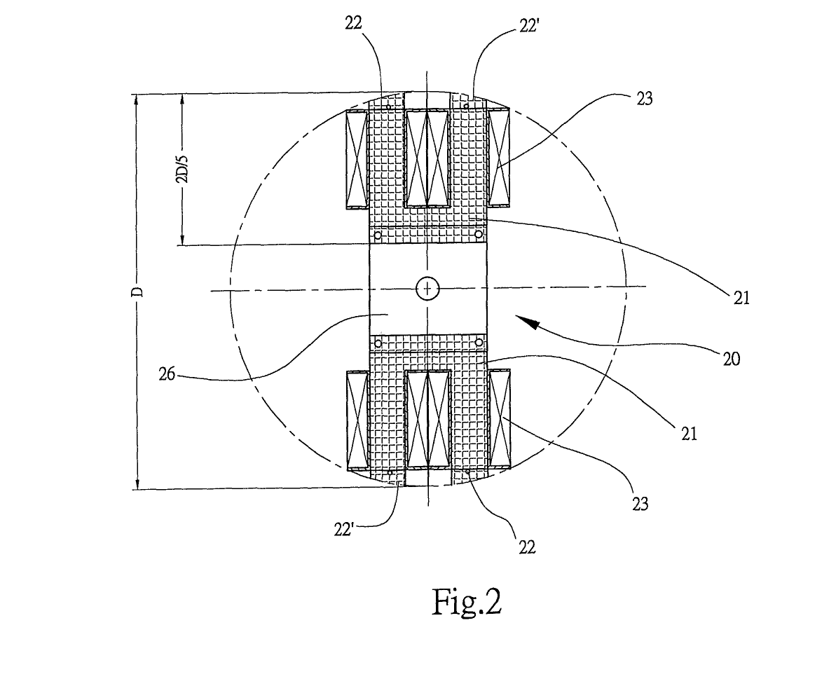

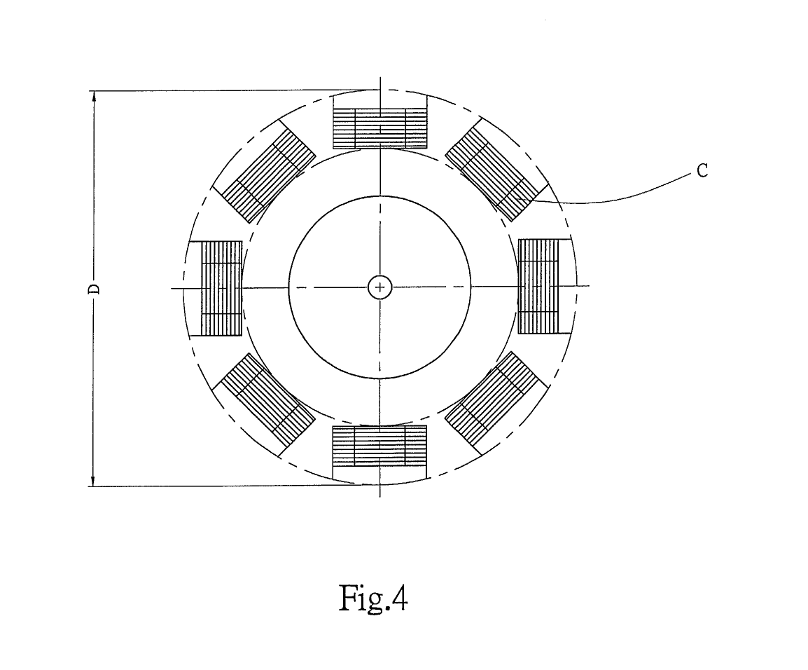

Referring to FIGS. 2 and 4 for comparison of the prior art device and the present invention. FIG. 4 is a sketch view for flux distribution of a prior art exciting coil (C) and in which the flux is distributed along the perimeter thereof. For example, if there are eight poles or twelve poles, the waste area of each silicon steel is about a square of the diameter (D²). However, as shown in FIG. 2, the area required by the silicon steel 21 is less than the square of 2D/5 ([2D/5]²). If there are two silicon steels, the area required would be 8/25, which is less than one third of the square of the diameter. In light of this, it can be readily appreciated that the material used in the present invention can be reduced for more than one half to two third. Accordingly, the cost for the silicon steel 21 and the exciting coil 23 can be significantly reduced.

Regarding to the braking force, since the dynamo is eliminated from the assembly, accordingly the space for turns of the exciting coils 23 is increased and which is focused on the limited exciting coils 23. According to the preferred embodiment, the turns on the poles 22, 22′ has been tripled as compared to the prior art. As a result, the magnetic flux generated by those tripled turns of the exciting coils 23 within a gap 24 are also tripled.

Because the flux density achieved by the assembly in accordance with the present invention is still far away from the saturated flux density of the silicon steel, the magnetic resistance of the silicon steel can be neglected accordingly. Because the braking force is proportional to the square of the flux density, i.e. F=KB²A, wherein F is force, B is flux density, and A is reaction area. As a result, when the flux density is tripled, the braking force is increased to nine times as compared to the original if the reaction area remains unchanged. Accordingly, the effect of increasing flux density overcomes the decrease of reaction area. In light of this, the braking performance can be increased.

On the other hand, the assembly of the exciting coil can be easily wound, while the laborious work can be also reduced. Furthermore, the overall structure can be strengthened. For example, the conventional exciting coil (C) can only be wound to the poles when the silicon steels are stacked. In addition, the conventional exciting coils are wound by manually or automatically with high cost winding machine, which both increase the manufacturing cost. By the way, each layer of turns has to be completely isolated from the other layer of turns, the reliability of the insulation is therefore tempered.

In the present invention, the exciting coils 23 can be firstly and quickly wound on a rack 25 with a low-cost, high-speed winding machine, then the subassembly can be directly disposed on the poles 22, 22′. By this arrangement, only a dowel is used to correctly align the mounting of the subassembly. For this, not only the insulation between the layers of turns can be improved, the manufacturing cost is also reduced.

It will be understood that the invention may be embodied in other specific forms without departing from the spirit or central characteristics thereof. The present example and embodiment, therefore, is to be considered in all respects as illustrative and not restrictive, and the invention is not to be limited to the details given herein.

I claim:

1. A braking assembly, comprising:
a rotor defining a circular receiving space, a copper or aluminum ring being arranged within said receiving space for increasing the braking effect;
a stator being arranged within said receiving space of said rotor and including a plurality of poles, each pole being arranged with an exciting coils; and
wherein each said coil is configured by a pair of “U” shaped silicon steel symmetrically and secured to a plastic rack.

2. The braking assembly as recited in claim 1, wherein said exciting coil is firstly wound and then enveloped onto said corresponding pole.
